(19) United States
(12) Patent Application Publication
(10) Pub. No.: US 2026/0316330 A1
(43) Pub. Date: Oct. 15, 2026

(54) APPARATUS AND METHOD FOR FORMING A COMPOSITE COMPONENT

(71) Applicant: General Electric Company, Evendale, OH (US)

(72) Inventor: Johnnattan Tennessee Ugarte, Loveland, OH (US)

(21) Appl. No.: 19/177,187

(22) Filed: Apr. 11, 2025

(51) Int. Cl. B28B 7/30; B28B 23/00; B29C 33/48; B29C 70/34

(52) U.S. Cl. CPC B28B 7/30; B28B 23/0006; B29C 33/485; B29C 70/345

(57) ABSTRACT

An apparatus for forming a composite component includes a mandrel body defining one or more first forming surfaces on which the composite component can be formed and defining an interior cavity. A mandrel section is movably coupled to the mandrel body and defines one or more second forming surfaces on which the composite component can be formed. The mandrel section is movable from a retracted position within the interior cavity to an extended position. In the extended position, the one or more second forming surfaces are positioned to form a smooth transition to the one or more first forming surfaces. An actuation mechanism is actuable to move the mandrel section from the retracted position to the extended position.

### FIELD

The present subject matter relates generally to an apparatus and method for forming a composite component.

### BACKGROUND

A gas turbine engine generally includes a fan and a core arranged in flow communication with one another. Additionally, the core of the gas turbine engine general includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

Composite materials typically include a fiber-reinforced matrix and exhibit a high strength to weight ratio. Due to the high strength to weight ratio and moldability to adopt relatively complex shapes, composite materials are utilized in various applications, such as a turbine engine or an aircraft. Composite materials can be, for example, installed on or define a portion of the fuselage and/or wings, rudder, manifold, airfoil, or other components of the aircraft or turbine engine.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of an exemplary gas turbine engine according to various embodiments of the present subject matter.

FIG. 2 is a close-up, side view of a combustion section and a turbine section of the exemplary gas turbine engine of FIG. 1.

FIG. 3 is a schematic cross-section view of an exemplary apparatus for forming a composite component according to various embodiments of the present disclosure.

FIG. 4 is a side, schematic view of an exemplary mandrel of an exemplary apparatus for forming a composite component according to various embodiments of the present disclosure.

FIG. 5A is schematic, partial section view of a portion of the mandrel of FIG. 4 depicting an exemplary movable mandrel section in a retracted position according to various embodiments of the present disclosure.

FIG. 5B is schematic, partial section view of a portion of the mandrel of FIG. 4 depicting an exemplary movable mandrel section in an extended position according to various embodiments of the present disclosure.

FIG. 6A is schematic, partial section view of a portion of the mandrel of FIG. 4 depicting an exemplary movable mandrel section in a retracted position according to various embodiments of the present disclosure.

FIG. 6B is schematic, partial section view of a portion of the mandrel of FIG. 4 depicting an exemplary movable mandrel section in an extended position according to various embodiments of the present disclosure.

FIG. 7A is a schematic, section view of a portion of an exemplary apparatus for forming a composite component according to various embodiments of the present disclosure with an exemplary movable mandrel section in a first position.

FIG. 7B is a schematic, section view of a portion of an exemplary apparatus for forming a composite component according to various embodiments of the present disclosure with an exemplary movable mandrel section in a second position.

FIG. 8 is a schematic, enlarged, section view of a portion of an exemplary apparatus for forming a composite component according to various embodiments of the present disclosure.

FIG. 9 is a schematic perspective view of an exemplary insert depicted in the exemplary apparatus of FIG. 8.

FIG. 10 is a flow diagram of an exemplary method of forming an exemplary composite component in accordance with an embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The phrases “from X to Y” and “between X and Y” each refers to a range of values inclusive of the endpoints (i.e., refers to a range of values that includes both X and Y).

The terms “coupled,” “fixed,” “attached to,” and the like refer to both direct coupling, fixing, or attaching, as well as indirect coupling, fixing, or attaching through one or more intermediate components or features, unless otherwise specified herein.

The term “proximate” refers to being closer to one end than an opposite end. For example, when used in conjunction with first and second ends; high pressure and low pressure sides; or the like, the phrase “proximate the first end,” or “proximate the high pressure side,” refers to a location closer to the first end than the second end, or closer to the high pressure side than the low pressure side, respectively.

As used herein, the terms “first”, “second”, and “third” may be used interchangeably to distinguish one component from another and are not intended to signify location or importance of the individual components.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

The term “adjacent” as used herein with reference to two walls and/or surfaces refers to the two walls and/or surfaces contacting one another, or the two walls and/or surfaces being separated only by one or more nonstructural layers and the two walls and/or surfaces and the one or more nonstructural layers being in a serial contact relationship (i.e., a first wall/surface contacting the one or more nonstructural layers, and the one or more nonstructural layers contacting the a second wall/surface).

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine.

The terms “forward” and “aft” refer to relative positions within a gas turbine engine or vehicle, and are based on a normal operational attitude of the gas turbine engine or vehicle. More particularly, forward and aft are used herein with reference to a direction of travel of the vehicle and a direction of propulsive thrust of the gas turbine engine.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the terms “axial” and “axially” refer to directions and orientations that extend substantially parallel to a centerline of the gas turbine engine. Moreover, the terms “radial” and “radially” refer to directions and orientations that extend substantially perpendicular to the centerline of the gas turbine engine. In addition, as used herein, the terms “circumferential” and “circumferentially” refer to directions and orientations that extend arcuately about the centerline of the gas turbine engine.

As used herein, the term “composite material” refers to a material produced from two or more constituent materials, wherein at least one of the constituent materials is a non-metallic material. Example composite materials include polymer matrix composites (PMC), ceramic matrix composites (CMC), chopped fiber composite materials, etc.

As used herein, polymer matrix composites or “PMC” refers to a class of materials that include a polymer resin matrix and fibers that are stronger than the matrix, stiffer than the matrix, or both. The fibers may be a variety of materials, nonlimiting examples of which include carbon (e.g., graphite) fibers, glass (e.g., fiberglass) fibers, polymer (e.g., Kevlar®) fibers, basalt fibers, ceramic fibers (e.g. silicon carbide or alumina) and metal fibers. Resins for PMC matrix materials can be generally classified as thermosets or thermoplastics. Thermoplastic resins are generally categorized as polymers that can be repeatedly softened and flowed when heated and hardened when sufficiently cooled due to physical rather than chemical changes. Notable example classes of thermoplastic resins include nylons, thermoplastic polyesters, polyaryletherketones, and polycarbonate resins. Specific examples of high performance thermoplastic resins that have been contemplated for use in aerospace applications include polyetheretherketone (PEEK), polyetherketoneketone (PEKK), polyetherimide (PEI), and polyphenylene sulfide (PPS). In contrast, once fully cured into a hard rigid solid, thermoset resins do not undergo significant softening when heated but, instead, thermally decompose when sufficiently heated. Notable examples of thermoset resins include epoxy, bismaleimide (BMI), polyesters, vinylesters, phenolics, and polyimide resins.

PMC materials are produced in various forms for different types for manufacturing. PMC manufacturing may be generally classified into two types: (1) prepreg layup where the operators start with materials where the fibers are preimpregnated with resin usually in thin layers which may be placed in a mold and cured to form the part; and (2) infusion where dry fibers are assembled into a preform shape and resin is infused or injected into the dry preform. There are also many subvariants of these two approaches.

Prepregs may be unidirectional fibers impregnated with resin or fabrics with fibers in multiple directions (e.g., woven fabrics, braids, non-crimp fabrics, uniweave fabrics) impregnated with resin and are typically 0.002 inches (in) to 0.050 in thick. Prepregs may come in wide rolls where the manufacturer cuts ply shapes, stack the cut ply shapes into the mold and cures the cut ply shapes in the mold to make the final shape. Prepregs may be slit into narrower widths (e.g., ⅛ in to 12 in) and applied to a mold using automated fiber placement (AFP), then cured to create a final geometry. Prepregs may also be slit and chopped into small chips (e.g., 1 in×2 in, ½ in×1 in, 1 in×1 in), dropped randomly into a mold and cured to make a part.

For infusion, the dry preform may be produced in various ways. Layers of dry woven fabric, braid, and/or non-crimp fabric may be stacked together into a shape. Fibers may be woven into a final shape using 3D weave to create the preform. The resin may also be introduced in various ways. The resin may be introduced via vacuum assisted transfer molding (VARTM) where the dry preform is enclosed in a vacuum bag under vacuum and the resin is introduced into the dry preform under vacuum pressure. Resin transfer molding (RTM) may be used where the preform is placed into a closed mold and the resin is injected into the preform under pressure.

As will be appreciated, these are all examples and non-limiting.

As used herein, ceramic-matrix-composite or “CMC” refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO2), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (A12O3), silicon dioxide (SiO₂), aluminosilicates such as mullite, or mixtures thereof), or mixtures thereof.

Generally, particular CMCs may be referred to as their combination of type of fiber/type of matrix. For example, C/SiC for carbon-fiber-reinforced silicon carbide; SiC/SiC for silicon carbide-fiber-reinforced silicon carbide, SiC/SiN for silicon carbide fiber-reinforced silicon nitride; SiC/SiC—SiN for silicon carbide fiber-reinforced silicon carbide/silicon nitride matrix mixture, etc. In other examples, the CMCs may include a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al₂O₃·2SiO₂), as well as glassy aluminosilicates.

In certain embodiments, the reinforcing fibers may be bundled and/or coated prior to inclusion within the matrix. For example, bundles of the fibers may be formed as a reinforced tape, such as a unidirectional reinforced tape. A plurality of the tapes may be laid up together to form a preform component. The bundles of fibers may be impregnated with a slurry composition prior to forming the preform or after formation of the preform. The preform may then undergo thermal processing and subsequent chemical processing to arrive at a component formed of a CMC material having a desired chemical composition. For example, the preform may undergo a cure or burn-out to yield a high char residue in the preform, and subsequent melt-infiltration with silicon, or a cure or pyrolysis to yield a silicon carbide matrix in the preform, and subsequent chemical vapor infiltration with silicon carbide. Additional steps may be taken to improve densification of the preform, either before or after chemical vapor infiltration, by injecting it with a liquid resin or polymer followed by a thermal processing step to fill the voids with silicon carbide. CMC material as used herein may be formed using any known or hereinafter developed methods including but not limited to melt infiltration, chemical vapor infiltration, polymer impregnation pyrolysis (PIP), or any combination thereof.

Such materials, along with certain monolithic ceramics (i.e., ceramic materials without a reinforcing material), are particularly suitable for higher temperature applications. Additionally, these ceramic materials are lightweight compared to superalloys, yet can still provide strength and durability to the component made therefrom. Therefore, such materials are currently being considered for many gas turbine components used in higher temperature sections of gas turbine engines, such as airfoils (e.g., turbines, and vanes), combustors, shrouds and other like components, that would benefit from the lighter-weight and higher temperature capability these materials can offer.

In the present disclosure, when a layer is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

Embodiments of the present disclosure include a mandrel on which a layup of one or more layers of material may be placed that has mechanically retractable portions to obtain a volume reduction of the layup before placement into a tool for curing. Because of dimensional differences between wet plies and post-cured or dry plies, the material layup may result in an excess volume within an inner space of the tool, which may lead to pinching spots in the material layup, which may result in surface tooling marks as well as wrinkles, cracks, and or separation of the plies forming the component. Internally, the pinching of plies may also translate to fiber in-plane buckling, which may have detrimental material effects. Embodiments of the present disclosure mechanically reduce the size of the mandrel by having movable mandrel sections that retract into its inner volume resulting in a volume gain (e.g., a volume reduction of the lay-up on the mandrel) enabling the tool to close around the layup without interference. After the tool is closed, portions of the mandrel may be moved to move various portions of the layup into their intended positions within the tool in an organized manner. Thus, embodiments of the present disclosure substantially reduce and/or eliminate the likelihood of in-plane buckling of the plies as well as surface tooling marks and cracks. Embodiments of the present disclosure also improve composite components used in environments having flowpath surfaces by substantially eliminating or reducing exposed fibers on the flowpath surfaces. Accordingly, embodiments of the present disclosure reduced the cavity volume of the material assembly on the mandrel in a mechanical manner, enabling for variables such as fiber ply thickness variation and fiber placement variation to be absorbed by volume reduction and strategically timed mechanical expansion of portions of the mandrel ahead of thermal processing of the layup. Additionally, in exemplary embodiments, a thermally expanding material may be positioned between the composite ply material and the mandrel such that during thermal processing of the composite ply material, the thermally expanding material expands and applies a compaction pressure to the composite ply material. In exemplary embodiments, an insert may be embedded in the thermally expanding material to provide a stiffness level in a particular direction to control a dimension and/or contour of an interior cavity of the composite component and shape the compaction of the composite ply material. Thus, in exemplary embodiments, the insert is configured to provide pressure in a desired direction while enabling expansion of the thermally expanding material in other directions where variability of a dimensional tolerance of the thermally expanding material and/or the composite ply material may be acceptable.

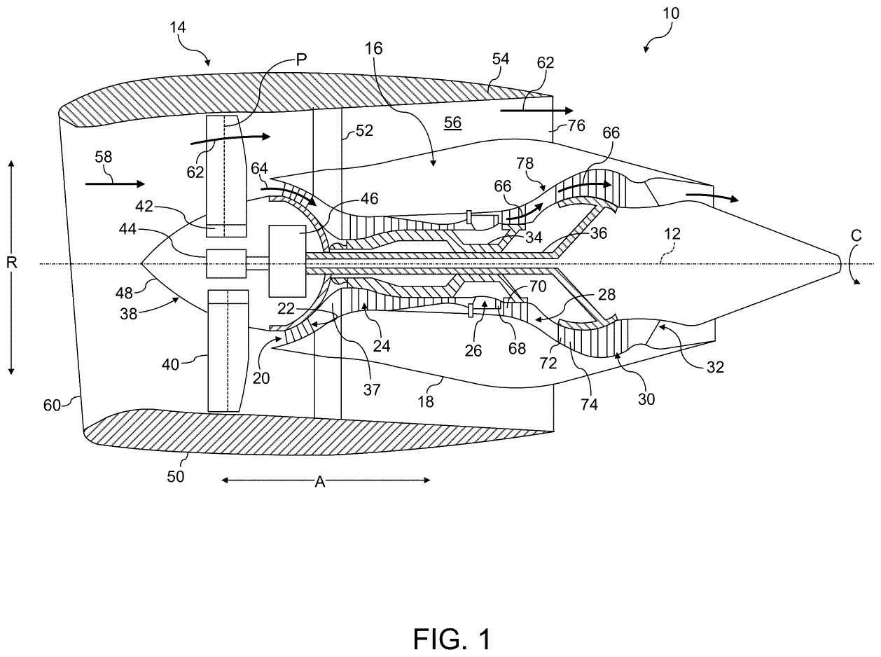

Referring now to the drawings, wherein identical numerals indicate the same elements throughout the Figures, FIG. 1 is a schematic cross-sectional view of a gas turbine engine 10 in accordance with an exemplary embodiment of the present disclosure. More particularly, for the embodiment of FIG. 1, the gas turbine engine is a high-bypass turbofan jet engine, sometimes also referred to as a “turbofan engine.” As shown in FIG. 1, the gas turbine engine 10 defines an axial direction A (extending parallel to a longitudinal axis 12 provided for reference), a radial direction R, and a circumferential direction C extending about the longitudinal axis 12. In general, the gas turbine engine 10 includes a fan section 14 and a turbomachine 16 disposed downstream from the fan section 14.

The exemplary turbomachine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft 34 (which may additionally or alternatively be a spool) drivingly connects the HP turbine 28 to the HP compressor 24. A low pressure (LP) shaft 36 (which may additionally or alternatively be a spool) drivingly connects the LP turbine 30 to the LP compressor 22. The compressor section, combustion section 26, turbine section, and jet exhaust nozzle section 32 together define a working gas flowpath 37.

For the embodiment depicted, the fan section 14 includes a fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40, e.g., in unison. The gas turbine engine 10 further includes a power gearbox 46, and the fan blades 40, disk 42, and pitch change mechanism 44 are together rotatable about the longitudinal axis 12 by LP shaft 36 across the power gearbox 46. The power gearbox 46 includes a plurality of gears for adjusting a rotational speed of the fan 38 relative to a rotational speed of the LP shaft 36, such that the fan 38 may rotate at a more efficient fan speed.

Referring still to the exemplary embodiment of FIG. 1, the disk 42 is covered by a rotatable front hub 48 of the fan section 14 (sometimes also referred to as a “spinner”), the front hub 48 aerodynamically contoured to promote an airflow through the plurality of fan blades 40.

Additionally, the exemplary fan section 14 includes an annular fan casing or outer nacelle 50 that circumferentially surrounds the fan 38 and/or at least a portion of the turbomachine 16. It should be appreciated that the outer nacelle 50 is supported relative to the turbomachine 16 by a plurality of circumferentially-spaced outlet guide vanes 52 in the embodiment depicted. Moreover, a downstream section 54 of the outer nacelle 50 extends over an outer portion of the turbomachine 16 so as to define a bypass airflow passage 56 therebetween.

During operation of the gas turbine engine 10, a volume of air 58 enters the gas turbine engine 10 through an associated inlet 60 of the outer nacelle 50 and fan section 14. As the volume of air 58 passes across the fan blades 40, a first portion of air 62 is directed or routed into the bypass airflow passage 56 and a second portion of air 64 is directed or routed into the working gas flowpath 37, or more specifically into the LP compressor 22. The ratio between the first portion of air 62 and the second portion of air 64 is commonly known as a bypass ratio. A pressure of the second portion of air 64 is then increased as it is routed through the HP compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, thereby supporting operation of the LP compressor 22 and/or rotation of the fan 38.

The combustion gases 66 are subsequently routed through the jet exhaust nozzle section 32 of the turbomachine 16 to provide propulsive thrust.

Simultaneously, the pressure of the first portion of air 62 is substantially increased as the first portion of air 62 is routed through the bypass airflow passage 56 before it is exhausted from a fan nozzle exhaust section 76 of the gas turbine engine 10, also providing propulsive thrust. The HP turbine 28, the LP turbine 30, and the jet exhaust nozzle section 32 at least partially define a hot gas path 78 for routing the combustion gases 66 through the turbomachine 16.

It should be appreciated, however, that the exemplary gas turbine engine 10 depicted in FIG. 1 is by way of example only, and that in other exemplary embodiments, the gas turbine engine 10 may have any other suitable configuration.

For example, although the gas turbine engine 10 depicted is configured as a ducted gas turbine engine (i.e., including the outer nacelle 50), in other embodiments, the gas turbine engine 10 may be an unducted gas turbine engine (such that the fan 38 is an unducted fan, and the outlet guide vanes 52 are cantilevered from the outer casing 18). Additionally, or alternatively, although the gas turbine engine 10 depicted is configured as a geared gas turbine engine (i.e., including the power gearbox 46) and a variable pitch gas turbine engine (i.e., including a fan 38 configured as a variable pitch fan), in other embodiments, the gas turbine engine 10 may additionally or alternatively be configured as a direct drive gas turbine engine (such that the LP shaft 36 rotates at the same speed as the fan 38), as a fixed pitch gas turbine engine (such that the fan 38 includes fan blades 40 that are not rotatable about a pitch axis P), or both. It should also be appreciated, that in still other exemplary embodiments, aspects of the present disclosure may be incorporated into any other suitable gas turbine engine. For example, in other exemplary embodiments, aspects of the present disclosure may (as appropriate) be incorporated into, e.g., a turboprop gas turbine engine, a turboshaft gas turbine engine, or a turbojet gas turbine engine.

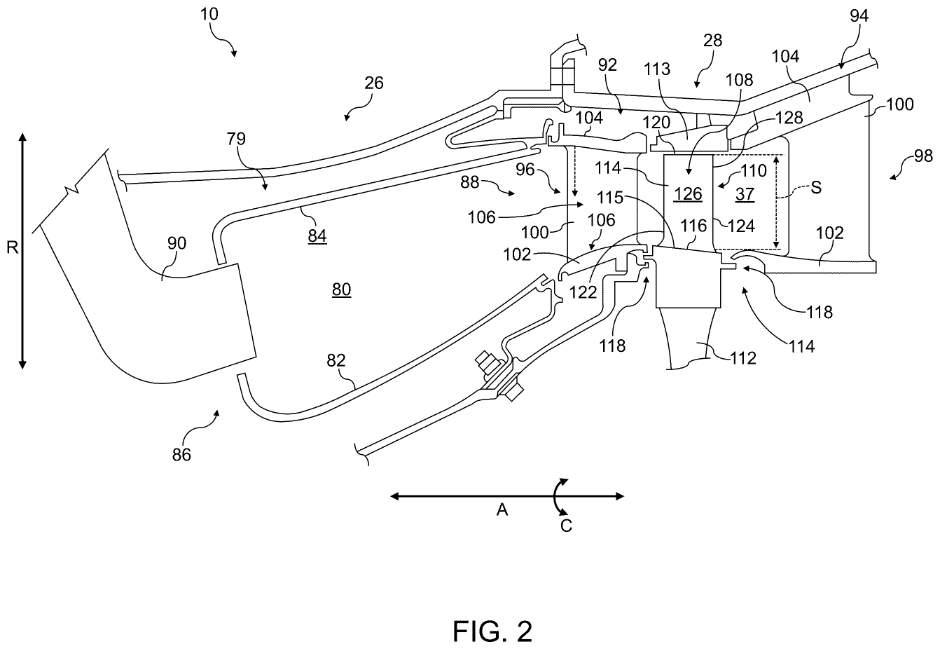

Referring now to FIG. 2, a schematic, close-up, cross-sectional view is provided of the gas turbine engine 10 of FIG. 1, and particularly of the combustion section 26 and the HP turbine 28 of the turbine section. The combustion section 26 depicted generally includes a combustor 79 having a combustion chamber 80 defined by an inner liner 82 and an outer liner 84, the combustion chamber 80 extending generally along the axial direction A from a forward end 86 to an aft end 88. A plurality of fuel nozzles 90 are positioned at the forward end 86 of the combustion chamber 80 for providing the combustion chamber 80 with a mixture of fuel and compressed air from the compressor section. As discussed above, the fuel and air mixture is combusted within the combustion chamber 80 to generate a flow of combustion gasses therethrough.

Downstream of the combustion section 26, the HP turbine 28 includes a plurality of turbine component stages, each turbine component stage comprising a plurality of turbine component sections. More particularly, for the embodiment depicted, the HP turbine 28 includes a plurality of turbine nozzle stages, as well as one or more stages of turbine rotor blades. Specifically, for the embodiment depicted, the HP turbine 28 includes a first turbine nozzle stage 92 and a second turbine nozzle stage 94, each configured to direct a flow of combustion gasses therethrough. The first turbine nozzle stage 92 includes a plurality of turbine nozzle sections 96 spaced along a circumferential direction C. Notably, the first turbine nozzle stage 92 is located immediately downstream from the combustion section 26, and thus may also be referred to as a combustor discharge nozzle stage having a plurality of combustion discharge nozzle sections. Additionally, for the exemplary embodiment depicted, the second turbine nozzle stage 94 also includes a plurality of turbine nozzle sections 98 spaced along the circumferential direction C.

Each of the turbine nozzle sections 96, 98 forming the first and second turbine nozzle stages 92, 94 includes a turbine nozzle 100 positioned within the working gas flowpath 37, exposed to and at least partially defining the working gas flowpath 37. The turbine nozzle 100 is configured as an airfoil. The turbine nozzle sections 96, 98, also include an endwall, or more particularly, an inner endwall 102 and an outer endwall 104. The nozzle 100 extends generally along the radial direction R from the inner endwall 102 to the outer endwall 104. The turbine nozzle 100, inner endwall 102, and outer endwall 104 each include a flowpath surface 106 at least partially exposed to the working gas flowpath 37.

Located immediately downstream of the first turbine nozzle stage 92 and immediately upstream of the second turbine nozzle stage 94, the HP turbine 28 includes a first turbine rotor blade stage 108. The first turbine rotor blade stage 108 includes a plurality of turbine rotor blade sections 110 spaced along the circumferential direction C and a first stage rotor disk 112. The plurality of turbine rotor blade sections 110 are attached to the first stage rotor disk 112, and although not depicted, the first stage rotor disk 112 is, in turn, connected to the HP shaft 34 (FIG. 1). The gas turbine engine 10 additionally includes a shroud 113 exposed to and at least partially defining the working gas flowpath 37. The shroud 113 is configured to form a seal with the first turbine rotor blade stage 108.

Each of the plurality of turbine rotor blade sections 110 includes a turbine rotor blade 114, a wall or platform 116, and a base 118. The rotor blade 114 is also configured as an airfoil, and extends outwardly along a spanwise direction (or rather, along the radial direction R when installed) to define a spanwise height S. Specifically, the rotor blade 114 extends along the radial direction R from a radially inner end 115 at the platform 116 to a tip 120 of the rotor blade 114. As will be appreciated, the tip 120 of the rotor blade 114 is configured to form a seal with the shroud 113.

Additionally, the turbine rotor blade 114 defines a leading edge 122 and an opposite trailing edge 124, as well as a pressure side 126 and an opposite suction side 128. During operation, hot combustion gases are generated in the combustion section and flow in a downstream direction over the turbine rotor blades 114, the turbine rotor blades 114 extracting energy therefrom for rotating the first stage rotor disk 112 supporting the rotor blades 114, which may in turn rotate the HP shaft 34.

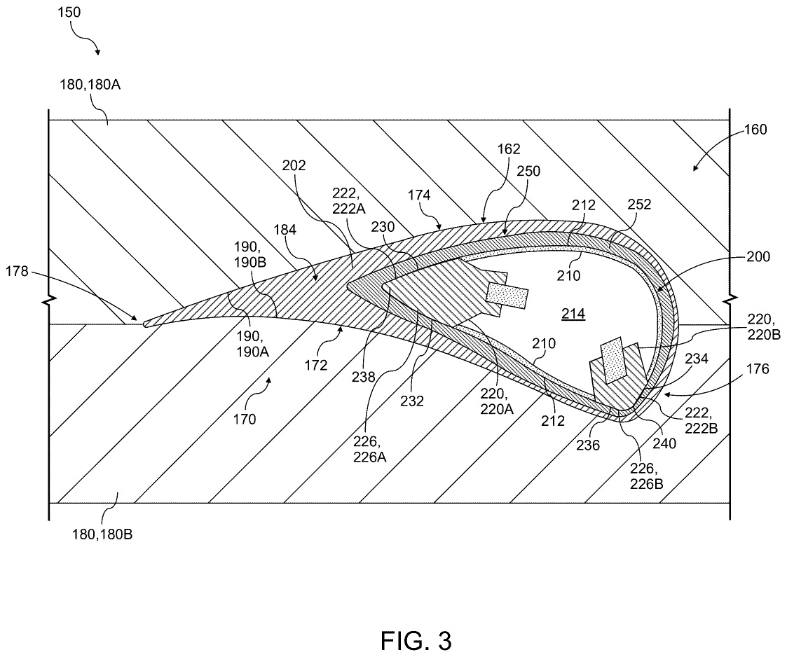

FIG. 3 is a schematic diagram illustrating an embodiment of an apparatus 150 for forming a composite component 160. In exemplary embodiments, the composite component 160 may be a CMC component; however, it should be understood that the apparatus 150 may be used to form other types of composite components. In the embodiment illustrated in FIG. 3, the composite component 160 is a stator vane 162. The stator vane 162 may be configured as the HP turbine stator vanes 68 and/or the LP turbine stator vanes 72 depicted in FIG. 1. However, it should be understood that that the composite component 160 may include other types of vanes or blades of the gas turbine engine 10 (FIGS. 1 and 2) such as, by way of non-limiting example, the HP turbine rotor blades 70 and/or the LP turbine rotor blades 74 (FIG. 1). The composite component 160 may also include other components of the gas turbine engine 10 such as, by way of non-limiting example, a shroud.

In FIG. 3, the stator vane 162 includes an airfoil 170 having a concave pressure side 172 opposite a convex suction side 174. The pressure side 172 and the suction side 174 extend between a leading edge 176 and an opposite trailing edge 178. In exemplary embodiments, the apparatus 150 includes one or more tooling portions 180 that define the contour or profile of the airfoil 170. In the embodiment depicted in FIG. 3, two tooling portions 180A, 180B are depicted that are couplable together to form a clamshell tool. In other words, in exemplary embodiments, the tooling portions 180A, 180B are rigid structures that may be coupled to each other defining an inner space 184 between the tooling portions 180A, 180B housing or containing the component to be formed. The tooling portions 180 each define one or more forming surfaces 190 that define the outer profile of the component to be formed, such as the profile of the airfoil 170. In the embodiment illustrated in FIG. 3, the tooling portion 180A includes one or more forming surfaces 190A, and the tooling portion 180B includes one or more forming surfaces 190B. In operation, uncured composite material for forming the composite component 160 and disposed on a mandrel 200 may be positioned within the inner space 184 defined by the tooling portions 180A, 180B, and the tooling portions 180A, 180B may be coupled together or closed such that the uncured composite material forming at least a portion of the composite component 160 is cured (e.g., processed using heat and/or pressure) while enclosed within the inner space 184 to produce an exterior profile of the composite component 160 corresponding to the forming surfaces 190.

In the embodiment illustrated in FIG. 3, the apparatus 150 includes the mandrel 200 on which a ply assembly 202 may be disposed. The ply assembly 202 may be a CMC ply assembly formed of a quantity of CMC plies. However, it should be understood that the ply assembly 202 may be formed of other constituent materials. In FIG. 3, the mandrel 200 includes a mandrel body 210 and one or more mandrel sections 220 that are movable with respect to the mandrel body 210. In exemplary embodiments, the one or more mandrel sections 220 are movably coupled to the mandrel body 210. In exemplary embodiments, the mandrel body 210 defines one or more forming surfaces 212 on which a stacked or layered arrangement of materials used to form the composite component 160 may be disposed such as, by way of non-limiting example, the ply assembly 202. In the embodiment illustrated in FIG. 3, the apparatus 150 includes two mandrel sections 220 identified as a mandrel section 220A and a mandrel section 220B. It should be understood that the apparatus 150 may include a greater or fewer quantity of movable mandrel sections 220. In exemplary embodiments, each mandrel section 220 defines one or more forming surfaces 222 on which a stacked or layered arrangement of materials used to form the composite component 160 may be disposed such as, by way of non-limiting example, the ply assembly 202. In the embodiment illustrated in FIG. 3, the mandrel section 220A defines one or more forming surfaces 222A, and the mandrel section 220B defines one or more forming surfaces 222B. The forming surfaces 212 and 222 together at least partly define an interior profile of the composite component 160.

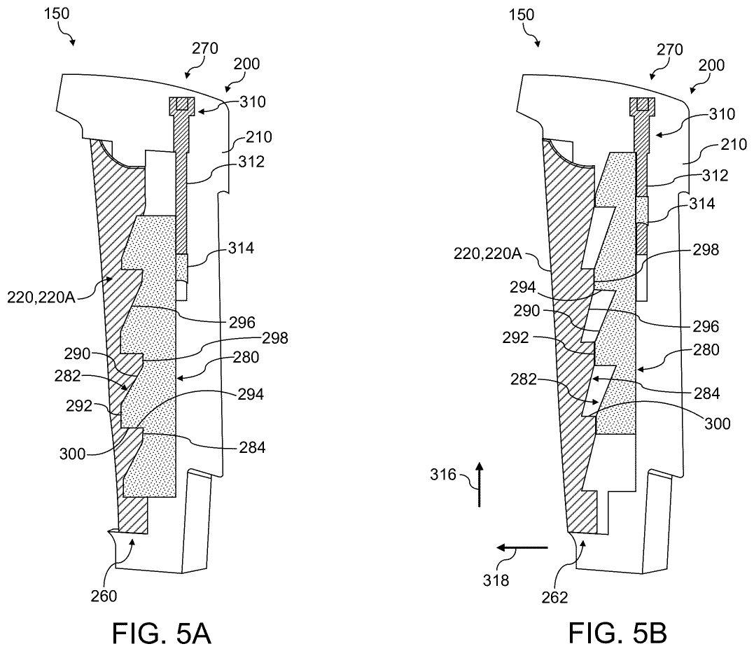

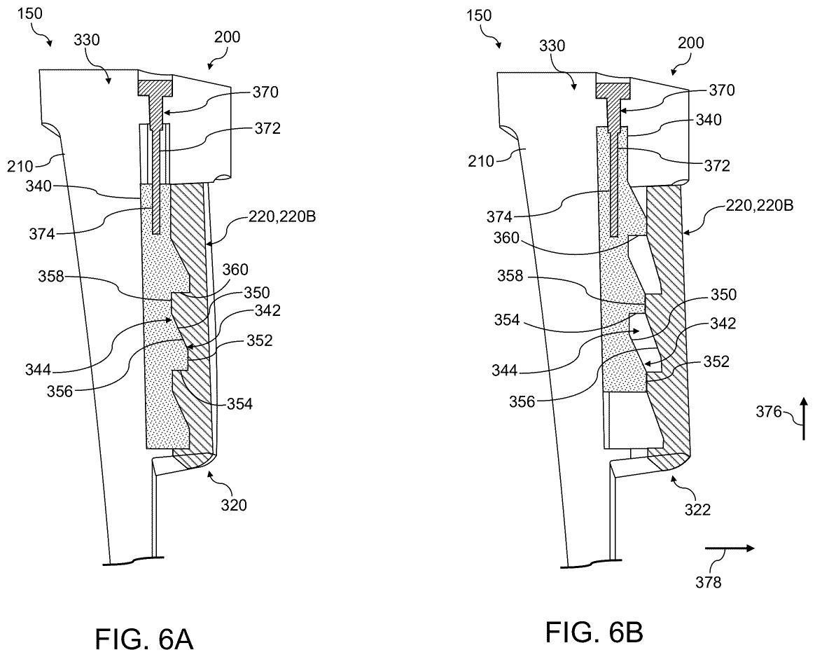

In exemplary embodiments, the mandrel body 210 and the mandrel sections 220 are rigid components configured to withstand a pressure applied during curing of the composite materials such as, by way of non-limiting example, by an autoclave, and provide a solid surface on which the composite materials may be applied or layered. In the embodiment illustrated in FIG. 3, the mandrel body 210 defines an interior cavity 214 such that at least a portion of the mandrel sections 220 is disposed in and movable within the interior cavity 214. As will be described in greater detail below at least in connection with FIGS. 5A-5B and 6A-6B, the mandrel sections 220 are movable with respect to the mandrel body 210 between a retracted position and an extended position. In FIG. 3, the mandrel sections 220A, 220B are depicted in an extended position with respect to the mandrel body 210 such that the forming surfaces 222 are positioned to form a smooth, non-stepped transition to adjacent forming surfaces 212. In other words, in the extended positions, the mandrel sections 220A, 220B are positioned with respect to the mandrel body 210 such that plies of the composite material transitioning from the forming surfaces 222 to adjacent forming surfaces 212 maintain a consistent fiber direction and/or orientation. In exemplary embodiments, in the extended positions, the mandrel sections 220A, 220B are positioned with respect to the mandrel body 210 such that the forming surfaces 222 are disposed in a substantially non-gapped arrangement or transition with respect to the forming surfaces 212. In other words, in exemplary embodiments, in the extended positions, the mandrel sections 220A, 220B are positioned with respect to the mandrel body 210 such that the forming surfaces 222 are located in close proximity to adjacently disposed forming surfaces 212 such that minimal or no bridging of a ply of the ply assembly 202 transitioning between the forming surfaces 212, 222 occurs. Thus, exemplary embodiments of the present disclosure enable the positioning of the mandrel sections 220 with respect to the mandrel body 210 to substantially prevent wrinkles, buckling, and/or unwanted ply deformation at the forming surface 212, 222 transitions.

In exemplary embodiments, at least a portion of the mandrel section 220 may be wedge-shaped. In the embodiment illustrated in FIG. 3, the mandrel sections 220 may include a wedge-shaped portion 226 positioned and/or oriented towards the ply assembly 202. In FIG. 3, the mandrel section 220A includes a wedge-shaped portion 226A, and the mandrel section 220B includes a wedge-shaped portion 226B. In exemplary embodiments, the wedge-shaped portion 226A includes an upper face 230 and a lower face 232 disposed at angles converging towards each other as the upper and lower faces 230, 232 transition toward a tip portion 238 of the mandrel section 220A. The wedge-shaped portion 226B includes an upper face 234 and a lower face 236 disposed at angles converging towards each other as the upper and lower faces 234, 236 transition toward a tip portion 240 of the mandrel section 220B. In the embodiment illustrated in FIG. 3, the upper and lower faces 230, 232 define at least a portion of the forming surfaces 222A, and the upper and lower faces 234, 236 define at least a portion of the forming surfaces 222B. In exemplary embodiments, the tip portions 238, 240 are disposed and/or oriented toward the ply assembly 202. In other words, the tip portions 238, 240 are disposed and/or oriented radially outward with respect to the interior cavity 214. In exemplary embodiments, the wedge-shaped portions 226 enable pressure to be applied in a radially outward direction with respect to the interior cavity 214 in the direction of the ply assembly 202 in response to movement of the mandrel sections 220 to their respective extended positions to move the plies of the ply assembly 202 into an intended position within the composite component 160. In other words, the mandrel sections 220 are moved from a retracted position within the interior cavity 214 in a radially outward direction with respect to the interior cavity 214 to apply a radially outward pressure to the ply assembly 202. The wedge-shaped portions 226 of the mandrel sections 220 also enable the withdrawing or retraction of the mandrel sections 220 in a direction away from the composite component 160 (e.g., in a radially inward direction with respect to the interior cavity 214) after curing of the composite component 160 without disrupting or damaging the ply assembly 202.

In the embodiment illustrated in FIG. 3, a thermally expanding material 250 is disposed or positioned on the mandrel 200 between the mandrel 200 and the ply assembly 202. In exemplary embodiments, the thermally expanding material 250 may be a room temperature vulcanizing (RTV) material. The thermally expanding material 250 may be a material having a known or controlled coefficient of thermal expansion such that during thermal processing of the composite component 160, the thermally expanding material 250 expands and applies a compaction pressure to the ply assembly 202. In the embodiment depicted in FIG. 3, the thermally expanding material 250 is an RTV sleeve 252 encircling the mandrel 200. The RTV sleeve 252 may be disposed on the forming surfaces 212, 222 before the application of the ply assembly 202 on the RTV sleeve 252. It should also be understood that the apparatus 150 may be used without the RTV sleeve 252 such that the ply assembly 202 is placed directly on the forming surfaces 212, 222.

In exemplary embodiments, the movable mandrel sections 220 enable an intended alignment and positioning of the thermally expanding material 250 and/or ply assembly 202 for curing or thermal processing to form the composite component 160 after their placement between closed tooling portions 180. Generally, the size or thickness of the thermally expanding material 250 may result in adverse effects due to a potential loss of geometry control as the thermally expanding material 250 softens in an elevated temperature state. Additionally, because of dimensional differences between wet plies and post-cured or dry plies, the layup of the thermally expanding material 250 and the ply assembly 202 may result in an excess volume within the inner space 184 between the closed tooling portions 180. This extra volume may lead to pinching spots in the ply assembly 202 which may result in surface tooling marks as well as wrinkles, cracks, and or separation of the plies forming the ply assembly 202 under a surface of the composite component. Internally, the pinching of plies may also translate to fiber in-plane buckling, which may have detrimental material effects. Embodiments of the present disclosure mechanically reduce the size of the mandrel 200 by breaking it down into movable mandrel sections 220 that retract into its volume (e.g., into its interior cavity 214). The retracted positions of the mandrel sections 220 generate a volume gain (e.g., a volume reduction of the lay-up on the mandrel 200) enabling the tooling portions 180 to close without interference. After the tooling portions 180 are closed, the mandrel sections 220 may be moved to their respective extended positions to move the thermally expanding material 250 and the plies of the ply assembly 202 into their intended position in an organized manner. Thus, embodiments of the present disclosure substantially reduce and/or eliminate the likelihood of in-plane buckling of the plies as well as surface tooling marks and cracks. Embodiments of the present disclosure also improve composite components used in environments having flowpath surfaces by substantially eliminating or reducing exposed fibers on the flowpath surfaces. Accordingly, embodiments of the present disclosure reduced the cavity volume of the material assembly on the mandrel 200 in a mechanical manner, enabling for variables such as fiber ply thickness variation and fiber placement variation to be absorbed by volume reduction and strategically timed mechanical expansion of portions of the mandrel 200 ahead of a thermal expansion of the thermally expanding material 250.

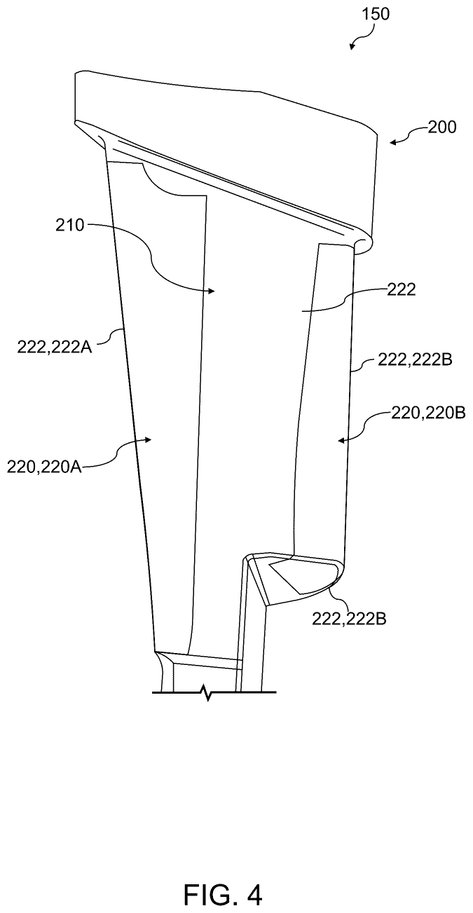

FIG. 4 is a schematic diagram depicting a side view of the mandrel 200 in accordance with an exemplary embodiment of the present disclosure. In the embodiment illustrated in FIG. 4, the mandrel sections 220A, 220B are depicted in an extended position with respect to the mandrel body 210 such that the forming surfaces 222A, 222B of the respective mandrel sections 220A, 220B provide a smooth transition to the adjacently disposed forming surface 222 of the mandrel body 210.

FIGS. 5A and 5B schematically depict a partial broken-out view of a portion of the mandrel 200 according to exemplary embodiments of the present disclosure. In FIGS. 5A and 5B, the positioning of the mandrel section 220A with respect to the mandrel body 210 is depicted. In particular, in FIG. 5A, the mandrel section 220A is depicted in a retracted position 260 with respect to the mandrel body 210, and FIG. 5B depicts the mandrel section 220A in an extended position 262 with respect to the mandrel body 210. In exemplary embodiments, the mandrel 200 includes one or more actuation mechanisms 270 that are actuable to cause movement of the mandrel section 220A between the retracted and extended positions 260, 262.

In the embodiment illustrated in FIGS. 5A and 5B, the actuation mechanism 270 includes an actuator body 280 movably coupled to the mandrel body 210 and the mandrel section 220A. In the exemplary embodiment depicted in FIGS. 5A and 5B, the actuator body 280 includes one or more ramp elements 282 disposed on a side of the actuator body 280 facing the mandrel section 220A that extend toward and mechanically engage one or more ramp elements 284 formed on the mandrel section 220A. The ramp elements 282 of the actuator body 280 have inclined surfaces 290 extending toward the mandrel section 220A that transition to landing areas 292 at a rise height 294 of the inclined surfaces 290. The ramp elements 284 of the mandrel section 220A have inclined surfaces 296 extending toward the actuator body 280 that transition to landing areas 298 at a rise height 300 of the inclined surfaces 296. In the retracted position 260 (FIG. 5A), the inclined surfaces 290 of the actuator body 280 are disposed in contact with the inclined surfaces 296 of the mandrel section 220A.

In the embodiment illustrated in FIGS. 5A and 5B, the actuation mechanism 270 includes a member 310 having threads 312 engageable with corresponding threads 314 formed on the actuator body 280. The member 310 may be a threaded fastener such as, by way of non-limiting example, a threaded bolt. In operation, rotation of the member 310 causes slidable movement or actuation of the actuator body 280 upwards based on the view of FIG. 5B in a direction 316 with respect to the mandrel body 210 and the mandrel section 220A based on the threaded engagement of the threads 312 with the threads 314. Thus, the actuator body 280 is slidably coupled to the mandrel section 220A via the ramp elements 282, 284. As the actuator body 280 moves in the direction 316, based on the slidable engagement of the inclined surfaces 290, 296 with each other, the mandrel section 220A is moved outwardly with respect to the actuator body 280 in a direction 318 to the extended position 262. In exemplary embodiments, the rise height 294 and/or the rise height 300 control the locations of the retracted and extended positions 260, 262 of the mandrel section 220A. In the extended position 262, the landing areas 292, 298 are in engagement with each other. In exemplary embodiments, the actuator body 280 includes at least two ramp elements 282 that have respective landing areas 292 that are spaced apart from each other (e.g., separated by one or more inclined surfaces 290) such that minimal tension force is applied to the member 310. Additionally, having at least two landing areas 292 that are spaced apart from each in contact with the mandrel section 220A substantially prevents any rocking or tilting movement of the mandrel section 220A. In the embodiment illustrated in FIGS. 5A and 5B, the ramp elements 282, 284 are used to convert translational motion of the actuator body 280 in the direction 316 to translational motion of the mandrel section 220A in the direction 318. However, it should be understood that other types of mechanisms may be used to effectuate the movement of the mandrel section 220A from the retracted position 260 to the extended position 262 such as, by way of non-limiting example, one or more cams located along the member 310 and/or the actuator body 280 that contact the mandrel section 220A such that rotation of the member 310 and/or the actuator body 280 and corresponding cams move the mandrel section 220A in the direction 318. It should be understood that rotation of the member 310 in a direction opposite that used to move the mandrel section 220A from the retracted position 260 to the extended position 262 will cause the actuator body 280 and the mandrel section 220A to move in directions opposite the respective directions 316, 318 to return the mandrel section 220A from the extended position 262 to the retracted position 260 (as depicted in FIG. 5A).

FIGS. 6A and 6B schematically depict a partial broken-out view of a portion of the mandrel 200 according to exemplary embodiments of the present disclosure. In FIGS. 6A and 6B, the positioning of the mandrel section 220B with respect to the mandrel body 210 is depicted. In particular, in FIG. 6A, the mandrel section 220B is depicted in a retracted position 320 with respect to the mandrel body 210, and FIG. 6B depicts the mandrel section 220B in an extended position 322 with respect to the mandrel body 210. In exemplary embodiments, the mandrel 200 includes one or more actuation mechanisms 330 that are actuable to cause movement of the mandrel section 220B between the retracted and extended positions 320, 322.

In the embodiment illustrated in FIGS. 6A and 6B, the actuation mechanism 330 includes an actuator body 340 movably coupled to the mandrel body 210 and the mandrel section 220B. In the exemplary embodiment depicted in FIGS. 6A and 6B, the actuator body 340 includes one or more ramp elements 342 disposed on a side of the actuator body 340 facing the mandrel section 220B that extend toward and mechanically engage one or more ramp elements 344 formed on the mandrel section 220B. The ramp elements 342 of the actuator body 340 have inclined surfaces 350 extending toward the mandrel section 220B that transition to landing areas 352 at a rise height 354 of the inclined surfaces 350. The ramp elements 344 of the mandrel section 220B have inclined surfaces 356 extending toward the actuator body 340 that transition to landing areas 358 at a rise height 360 of the inclined surfaces 356. In the retracted position 320 (FIG. 6A), the inclined surfaces 350 of the actuator body 340 are disposed in contact with the inclined surfaces 356 of the mandrel section 220B.

In the embodiment illustrated in FIGS. 6A and 6B, the actuation mechanism 330 includes a member 370 having threads 372 engageable with corresponding threads 374 formed on the actuator body 340. The member 370 may be a threaded fastener such as, by way of non-limiting example, a threaded bolt. In operation, rotation of the member 370 causes slidable movement or actuation of the actuator body 340 upwards based on the view of FIG. 6B in a direction 376 with respect to the mandrel body 210 and the mandrel section 220B based on the threaded engagement of the threads 372 with the threads 374. Thus, the actuator body 340 is slidably coupled to the mandrel section 220B via the ramp elements 342, 344. As the actuator body 340 moves in the direction 376, based on the slidable engagement of the inclined surfaces 350, 356 with each other, the mandrel section 220B is moved outwardly with respect to the actuator body 340 and the mandrel body 210 in a direction 378 to the extended position 322. In exemplary embodiments, the rise height 354 and/or the rise height 360 control the locations of the retracted and extended positions 320, 322 of the mandrel section 220B. In the extended position 322, the landing areas 352, 358 are in engagement with each other. In exemplary embodiments, the actuator body 340 includes at least two ramp elements 342 that have respective landing areas 352 that are spaced apart from each other (e.g., separated by one or more inclined surfaces 350) such that minimal tension force is applied to the member 370. Additionally, having at least two landing areas 352 that are spaced apart from each in contact with the mandrel section 220B substantially prevents any rocking or tilting movement of the mandrel section 220B. In the embodiment illustrated in FIGS. 6A and 6B, the ramp elements 342, 344 are used to convert translational motion of the actuator body 340 in the direction 376 to translational motion of the mandrel section 220B in the direction 378. However, it should be understood that other types of mechanisms may be used to effectuate the movement of the mandrel section 220B from the retracted position 320 to the extended position 322 such as, by way of non-limiting example, one or more cams located along the member 370 and/or the actuator body 340 that contact the mandrel section 220B such that rotation of the member 370 and/or the actuator body 340 and corresponding cams move the mandrel section 220B in the direction 378. It should be understood that rotation of the member 370 in a direction opposite that used to move the mandrel section 220B from the retracted position 320 to the extended position 322 will cause the actuator body 340 and the mandrel section 220B to move in directions opposite the respective directions 376, 378 to return the mandrel section 220B from the extended position 322 to the retracted position 320 (as depicted in FIG. 6A).

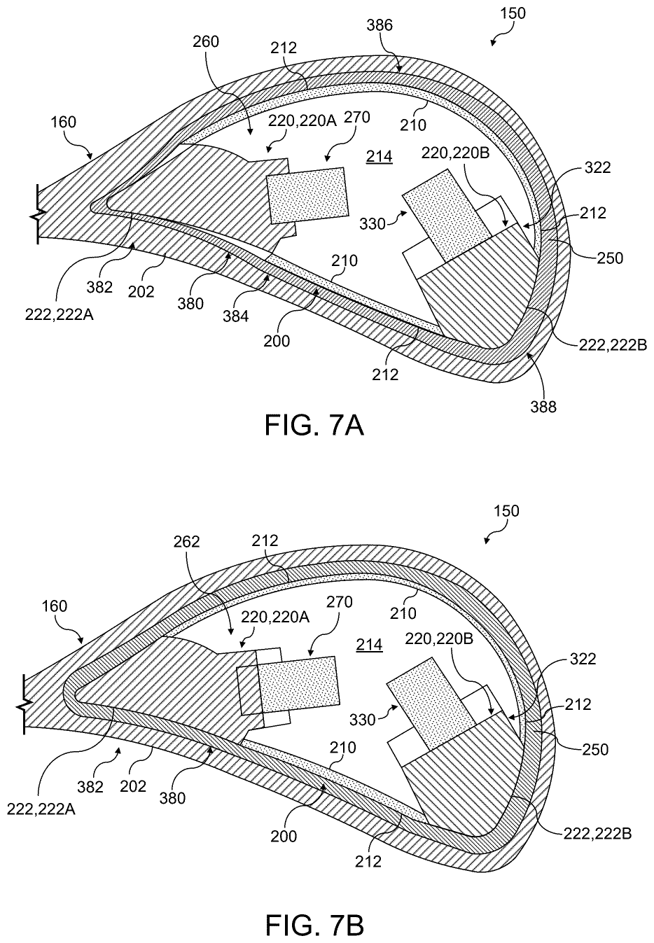

FIGS. 7A and 7B are schematic section views depicting an exemplary embodiment of the apparatus 150 according to the present disclosure. In the embodiment depicted in FIG. 7A, the mandrel section 220A is located in the retracted position 260 and the mandrel section 220B is located in the extended position 322. In FIG. 7B, the mandrel section 220A is located in the extended position 262 and the mandrel section 220B is located in the extended position 322. In exemplary embodiments, the actuation mechanisms 270, 330 are independently actuable to enable the respective mandrel sections 220A, 220B to be moved independently between their respective retracted positions 260, 320 (FIG. 6A) and extended positions 262, 322. Thus, in exemplary embodiments, movement or manipulation of the ply assembly 202 may be performed at different locations of the composite component 160 at different times and/or different sequences. However, it should also be understood that the actuation mechanisms 270, 330 may also be actuated in unison such that ganged movement of the mandrel sections 220A, 220B is provided.

In operation, in the exemplary embodiment depicted in FIGS. 7A and 7B, the thermally expanding material 250 is disposed on the mandrel 200, and the ply assembly 202 is placed on the thermally expanding material 250. The thermally expanding material 250 is located against the forming surface 212 of the mandrel body 210, the forming surface 222A of the mandrel section 220A, and the forming surface 222B of the mandrel section 220B. In other words, a portion 380 of the thermally expanding material 250 is located at least partly on the forming surface 222A, portions 384 and 386 of the thermally expanding material 250 are located at least partly on the forming surface 212 of the mandrel body 210, and a portion 388 of the thermally expanding material 250 is located at least partly on the forming surface 222B. In FIG. 7A, the mandrel section 220A is located in the retracted position 260 such that the portion 380 of the thermally expanding material 250 located on the forming surface 222A of the mandrel section 220A (along with a portion 382 of the ply assembly 202 positioned on the portion 380) is located radially inward with respect to the interior cavity 214 from an intended position of the portions 380, 382 during curing of the composite component 160. In other words, the forming surface 222A is located offset in a radially inward direction (e.g., toward the interior cavity 214) with respect to the adjacent forming surfaces 212. However, as depicted in FIG. 7B, with the mandrel section 220A moved into the extended position 262, the portions 380, 382 are pressed radially outward with respect to the interior cavity 214 (e.g., toward the forming surfaces 190 of the tooling portions 180 (FIG. 3)) to locate the portions 380, 382 in their intended positions during curing of the composite component 160. As described above, it should be understood that the thermally conducting material 250 may also be omitted for forming the composite component 160 such that the ply assembly 202 may be placed directly against the mandrel 200 as set forth above as described in connection with the thermally expanding material 250.

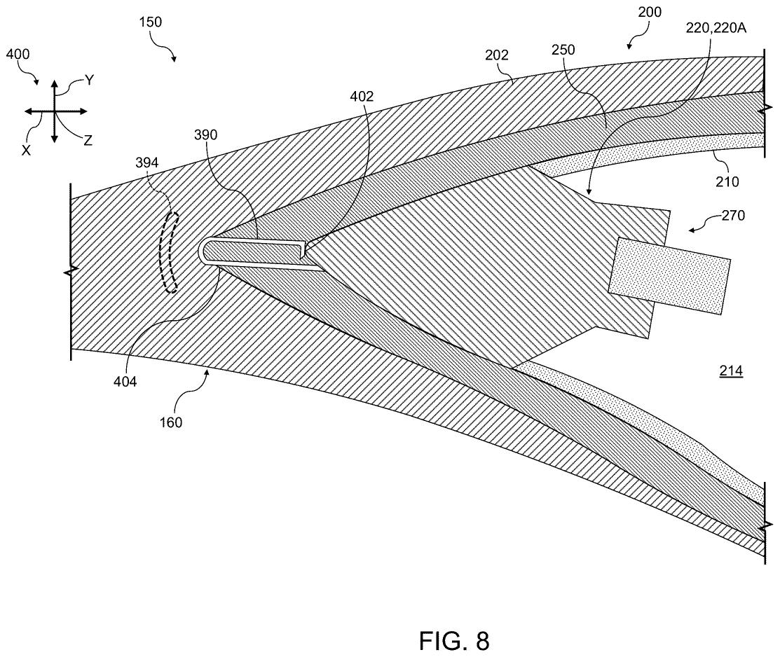

FIG. 8 is a schematic diagram illustrating the apparatus 150 according to another exemplary embodiment of the present disclosure. The apparatus 150 may be configured similar to as set forth and described in connection with FIGS. 3-7B. In the embodiment illustrated in FIG. 8, one or more inserts 390 may be embedded in the thermally expanding material 250. In exemplary embodiments, the insert 390 is a metal insert. In exemplary embodiments, the insert 390 is configured to provide a stiffness level in a particular direction to control a dimension and/or contour of an interior cavity of the composite component 160 and shape the compaction of the ply assembly 202 using the thermally expanding material 250 to shape the compaction from inside towards the outside (e.g., in a direction radially outward from the interior cavity 214). Thus, in exemplary embodiments, the insert 390 is configured to provide pressure in a desired direction while enabling expansion of the thermally expanding material 250 in other directions.

In the exemplary embodiment depicted in FIG. 8, the apparatus 150 includes the movable mandrel section 220A, and the insert 390 is positioned radially outward from the mandrel section 220A with respect to the interior cavity 214. However, it should be understood that the thermally expanding material 250 with the embedded insert 390 may be used in an embodiment of the apparatus 150 omitting the movable mandrel section 220A. In such an embodiment, the thermally expanding material 250 with the embedded insert 390 may be disposed on a solid or non-movable portion of the mandrel 200.

In FIG. 8, a coordinate system 400 is defined with an X axis, Y axis, and Z axis. In exemplary embodiments, the X axis may represent a lateral direction, the Y axis may represent a vertical direction, and the Z axis may represent a longitudinal direction with respect to the composite component 160. In the embodiment illustrated in FIG. 8, the insert 390 is configured to provide a stiffness level in the lateral direction greater than a stiffness level in the vertical direction. In FIG. 8, the insert 390 contacts the mandrel section 220A at one or more locations and extends outward away from the mandrel section 220A toward the ply assembly 202. In exemplary embodiments, the insert 390 extends from an interior surface 402 of the thermally expanding material 250 facing the mandrel 200 to an exterior surface 404 of the thermally expanding material 250 facing the ply assembly 202 and disposed radially outward from the mandrel section 220A. In the embodiment depicted in FIG. 8, the insert 390 is a C-shaped insert such that the insert 390 contacts at least a portion of the mandrel 200 at two locations that are spaced apart from each other in the vertical direction. Thus, in the embodiment depicted in FIG. 8, the insert 390 contacts at least a portion of the mandrel section 220A at two locations that are spaced apart from each other in the vertical direction.

In the embodiment depicted in FIG. 8, the insert 390 is configured to provide stiffness in the lateral direction corresponding to the movement direction of the mandrel section 220A (e.g., moving from the retracted position 260 (FIG. 7A) to the extended position 262 (FIG. 7B)) while enabling the thermally expanding material 250 to expand vertically where more variability of a dimensional tolerance of the ply assembly 202 and/or thermally expanding material 250 may be acceptable. In exemplary embodiments, the insert 390 may be configured having strategically located contact points with the mandrel 200 and/or the ply assembly 202 based on design considerations of the composite component 160 and the layup of the one or more layers or plies forming the ply assembly 202. In exemplary embodiments, the insert 390 may be located in one or more portions of the thermally expanding material 250 where a radius of the ply assembly 202 may pull away from its intended location such as, by way of non-limiting example, moving towards the interior cavity 214. In such a condition, internal voids may result, such as in an area 394 indicated by dashed lines in FIG. 8. In a CMC component, silicon veins may fill the void which may detrimentally affect material properties in that area 394. In accordance with embodiments of the present disclosure, the insert 390 mechanically reduces the variability of such internal voids by providing rigidity in the region of the thermally expanding material 250 in regions of concern while enabling the thermally expanding material 250 to expand in other locations and/or directions where variability of a dimensional tolerance of the thermally expanding material 250 and/or the ply assembly 202 may be acceptable.

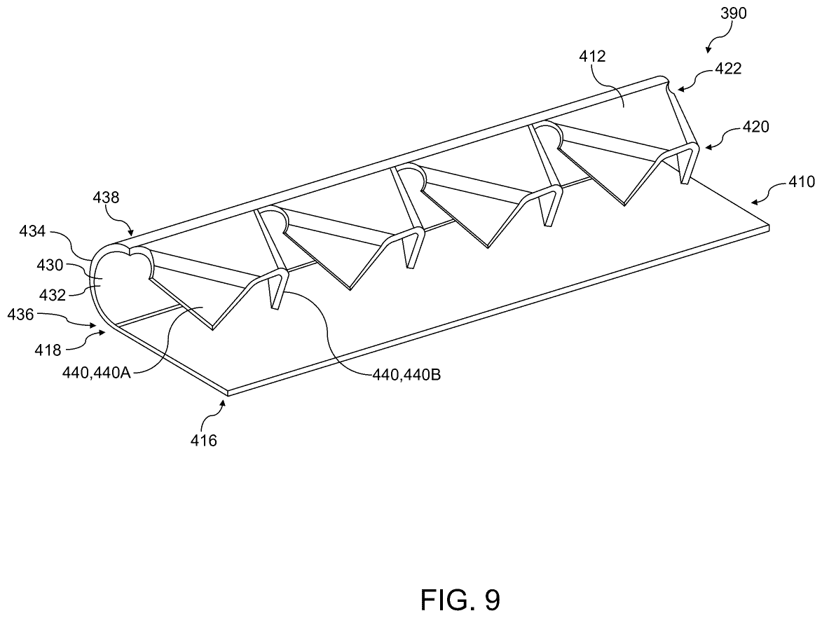

FIG. 9 is a schematic perspective view depicting an exemplary embodiment of the insert 390. In the embodiment illustrated in FIG. 9, the insert 390 includes one or more flange portions 410 disposed in a spaced apart relationship to one or more flange portions 412. In exemplary embodiments, the one or more flange portions 410 are disposed in a parallel arrangement with respect to the one or more flange portions 412. The one or more flange portions 410 define a first end 416 and a second end 418 located distal to the first end 416. In exemplary embodiments, the first end 416 is positioned proximate to and/or configured to contact the mandrel section 220A (FIG. 8) when the thermally expanding material 250 (FIG. 8) is placed on the mandrel 200 (FIG. 8). The one or more flange portions 412 include a first end 420 and a second end 422 located distal to the first end 420. In exemplary embodiments, the first end 420 is positioned proximate to and/or configured to contact the mandrel section 220A (FIG. 8) when the thermally expanding material 250 (FIG. 8) is placed on the mandrel 200 (FIG. 8).

In FIG. 9, the insert 390 includes a curved portion 430 extending between the flange portions 410, 412. In exemplary embodiments, the curved portion 430 has a concave surface 432 facing in a direction of the flange portions 410, 412 and a convex surface 434 facing in a direction opposite the flange portions 410, 412. The curved portion 430 defines a first end 436 connected to and/or extending from the second end 418 of the flange portion 410. The curved portion 430 defines a second end 438 distal to the first end 436 and connected to and/or extending from the second end 422 of the flange portion 412. In exemplary embodiments, the convex surface 434 is positioned facing toward and/or contacting the ply assembly 202 (FIG. 8).

In the embodiment illustrated in FIG. 9, the one or more flange portions 412 include one or more tab portions 440 extending toward the one or more flange portions 410. In FIG. 9, each flange portion 412 includes two oppositely disposed tab portions 440A, 440B being in a spaced apart relationship to each other. The tab portions 440A, 440B provide additional surface area at the first end 420 of the flange portion 412 for contacting the mandrel 200 (FIG. 8). Thus, the one or more tab portions 440 are positioned proximate to the interior surface 402 (FIG. 8) of the thermally expanding material 250 (FIG. 8) and/or in contact with the mandrel section 220A (FIG. 8) when the thermally expanding material 250 (FIG. 8) is placed on the mandrel 200 (FIG. 8). The tab portions 440A, 440B may be oriented parallel or non-parallel to each other.

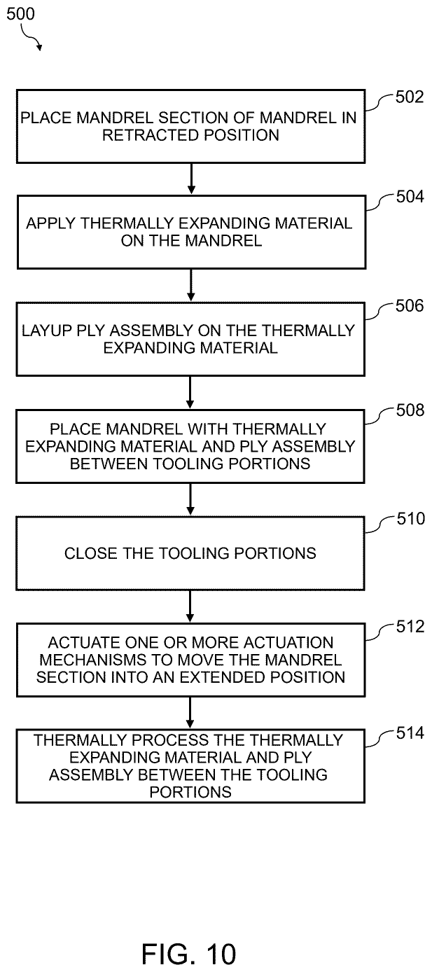

FIG. 10 provides a flow diagram of an exemplary method (500) of forming a composite component in accordance with exemplary embodiments of the present disclosure. For instance, the exemplary method (500) may be utilized for forming the composite component 160 such as, by way of non-limiting example, a CMC component. It should be appreciated that the method (500) is discussed herein only to describe exemplary aspects of the present subject matter and is not intended to be limiting.

At (502), the method (500) includes placing one or more mandrel sections 220 of the mandrel 200 in a retracted position 260, 320, such as depicted in FIGS. 5A, 6A, and 7A. At (504), the method (500) includes applying the thermally expanding material 250 on the mandrel 200, such as depicted in FIG. 3. As indicated above, the thermally expanding material 250 may include the insert 390, such as depicted in FIGS. 8 and 9, or the insert 390 may be omitted from the thermally expanding material 250. At (506), the method (500) includes laying up or applying the ply assembly 202 on the thermally expanding material 250, such as depicted in FIG. 3. At (508), the method (500) includes placing mandrel 200 supporting the thermally expanding material 250 and the ply assembly 202 between the tooling portions 180, and at (510), closing the tooling portions 180 such that the mandrel 200 supporting the thermally expanding material 250 and the ply assembly 202 is enclosed between the tooling portions 180, such as depicted in FIG. 3.

At (512), the method (500) includes actuating one or more actuation mechanisms 270, 330 to move the mandrel section 220 from the retracted position 260, 320 to the extended position 262, 322 and position the thermally expanding material 250 and the ply assembly 202 in an intended curing position for forming the composite component 160, such as depicted in FIG. 3). As described above, if multiple mandrel sections 220 are included on the mandrel 200, the mandrel sections 220 may be moved in a ganged manner or may be independently controlled and moved according to a particular sequence or scheme such as, by way of non-limiting example, sequentially moving different mandrel sections 220 by different amounts such that the individual mandrel sections 220 are gradually moved to their respective extended positions 262, 322. At (514), the method (500) includes thermally processing the thermally expanding material 250 and the ply assembly 202 within the tooling portions 180 to form the composite component 160. For a CMC component, such thermal processing may include a densification procedure to densify CMC plies forming the ply assembly 202.

Thus, embodiments of the present disclosure provide an apparatus and method for forming a composite component that includes a mandrel having rigid, mechanically retractable portions to obtain a volume reduction of the layup before placement into a tool for curing. Embodiments of the present disclosure mechanically reduce the size of the mandrel by having movable mandrel sections that retract into its inner volume resulting in a volume gain (e.g., a volume reduction of the lay-up on the mandrel) enabling tooling to close around the layup without interference. After the tool is closed, portions of the mandrel may be relocated to move various portions of the layup into their intended positions in an organized manner. Thus, embodiments of the present disclosure substantially reduce and/or eliminate the likelihood of in-plane buckling of the plies as well as surface tooling marks and cracks. Additionally, in exemplary embodiments, a thermally expanding material may be positioned between the composite ply material and the mandrel such that during thermal processing of the composite ply material, the thermally expanding material expands and applies a compaction pressure to the composite ply material. In exemplary embodiments, an insert may be embedded in the thermally expanding material to provide a stiffness level in a particular direction to control a dimension and/or contour of an interior cavity of the composite component and shape the compaction of the composite ply material from an inward-to-outward direction. Thus, in exemplary embodiments, the insert is configured to provide pressure in a desired direction while enabling expansion of the thermally expanding material in other directions where variability of a dimensional tolerance of the thermally expanding material and/or the composite ply material may be acceptable.

Although specific features of various embodiments may be shown in some drawings and not in others, this is for convenience only. In accordance with the principles of the present disclosure, any feature of a drawing may be referenced and/or claimed in combination with any feature of any other drawing.

Further aspects of the disclosure are provided by the subject matter of the following clauses:

An apparatus for forming a composite component, the apparatus comprising: a mandrel body defining one or more first forming surfaces on which the composite component can be formed, the mandrel body defining an interior cavity; a mandrel section movably coupled to the mandrel body, the mandrel section defining one or more second forming surfaces on which the composite component can be formed, the mandrel section movable from a retracted position within the interior cavity to an extended position, wherein, in the extended position, the one or more second forming surfaces are positioned to form a smooth transition to the one or more first forming surfaces; and an actuation mechanism actuable to move the mandrel section from the retracted position to the extended position.

The apparatus of the preceding clause, wherein the mandrel section is wedge-shaped.

The apparatus of any preceding clause, wherein the actuation mechanism comprises an actuator body slidably coupled to the mandrel section.

The apparatus of any preceding clause, wherein the actuation mechanism comprises an actuator body positioned to contact the mandrel section at two spaced apart locations.

The apparatus of any preceding clause, wherein the actuation mechanism comprises: an actuator body; and a rotatable member threadably coupled to the actuator body, wherein rotation of the rotatable member causes movement of the actuator body with respect to the mandrel section.

The apparatus of any preceding clause, wherein the actuation mechanism is disposed at least partly in the interior cavity.

The apparatus of any preceding clause, wherein the actuation mechanism comprises one or more ramp elements in slidable engagement with one or more ramp elements formed on the mandrel section.

An apparatus for forming a composite component, the apparatus comprising: a mandrel body defining one or more first forming surfaces on which the composite component can be formed, the mandrel body defining an interior cavity; a mandrel section movably coupled to the mandrel body, the mandrel section being wedged-shaped and defining one or more second forming surfaces on which the composite component can be formed, the mandrel section movable from a retracted position within the interior cavity to an extended position; and an actuation mechanism actuable to move the mandrel section from the retracted position to the extended position.

The apparatus of any preceding clause, wherein the actuation mechanism comprises an actuator body slidably coupled to the mandrel section.

The apparatus of any preceding clause, wherein the actuation mechanism comprises an actuator body positioned to contact the mandrel section at two spaced apart locations.

The apparatus of any preceding clause, wherein the actuation mechanism comprises: an actuator body; and a rotatable member threadably coupled to the actuator body, wherein rotation of the rotatable member causes movement of the actuator body with respect to the mandrel section.

The apparatus of any preceding clause, wherein the actuation mechanism is disposed at least partly in the interior cavity.

The apparatus of any preceding clause, wherein the actuation mechanism comprises one or more ramp elements in slidable contact with one or more ramp elements formed on the mandrel section.

The apparatus of any preceding clause, wherein the actuation mechanism comprises one or more ramp elements in slidable contact with one or more ramp elements formed on the mandrel section, and wherein at least one ramp element of the actuation mechanism comprises: an inclined surface; and a landing area extending from the inclined surface.

The apparatus of any preceding clause, wherein the actuation mechanism comprises at least one first ramp element having a first inclined surface and a first landing area extending from the first inclined surface, and wherein the mandrel section comprises at least one second ramp element having a second inclined surface and a second landing area extending from the second inclined surface, and wherein, in the extended position, the first landing area is in engagement with the second landing area.

The apparatus of any preceding clause, wherein the actuation mechanism moves the mandrel section from the retracted position to the extended position based on at least one of a rotational or a sliding actuation.

The apparatus of any preceding clause, wherein, in the extended position, the one or more second forming surfaces are positioned to form a non-stepped and non-gapped transition to the one or more first forming surfaces.

An apparatus for forming a composite component, comprising: a mandrel body defining an interior cavity, the mandrel body further defining one or more first forming surfaces on which a composite component can be formed; and first and second mandrel sections disposed at least partly within the interior cavity, the first and second mandrel sections independently movable within the interior cavity between respective first and second positions with respect to the first forming surfaces, the first and second mandrel sections each defining one or more second forming surfaces on which the composite component can be formed; and one or more actuation mechanisms actuable to move the first and second mandrel sections from the respective first positions to the respective second positions.

The apparatus of any preceding clause, wherein, in the respective first positions, the respective one or more second forming surfaces are located offset in a radially inward direction with respect to the one or more first forming surfaces.

The apparatus of any preceding clause, wherein the one or more actuation mechanisms are actuable to mechanically move the first and second mandrel sections from the respective first positions to the respective second positions.

An apparatus for forming a composite component, comprising: a rigid mandrel body defining an interior cavity, the mandrel body further defining one or more first forming surfaces on which a first portion of a ply assembly of the composite component can be formed; a rigid mandrel section disposed within the interior cavity, the mandrel section defining one or more second forming surfaces on which a second portion of the ply assembly of the composite component can be formed, the mandrel section positionable in a retracted position within the interior cavity during layup of the second portion of the ply assembly such that the one or more second forming surfaces are located offset in a radially inward direction with respect to the one or more first forming surfaces; and one or more actuation mechanisms actuable to move the mandrel section radially outward from the retracted position to move the second portion of the ply assembly into a curing position with respect to the first portion of the ply assembly.

An apparatus for forming a composite component, comprising: first and second tooling portions couplable together to define an inner space between the first and second tooling portions, wherein the first and second tooling portions define one or more forming surfaces at least partly defining a contour of the composite component; a mandrel positionable in the inner space such that a ply assembly supported by the mandrel is positioned between the mandrel and the one or more forming surfaces, where in the mandrel defines an interior cavity supporting one or more movable mandrel sections; and an actuation mechanism actuable after the first and second tooling portions are coupled together to move the one or more mandrel sections toward the one or more forming surfaces.

A method of forming a ceramic matrix composite (CMC) component, the method comprising: disposing a thermally expanding material on at least a portion of a mandrel, the mandrel comprising a mandrel body defining an interior cavity, wherein the mandrel comprises at least one mandrel section located in a retracted position within the interior cavity, the at least one mandrel section movably coupled to the mandrel body, the mandrel further comprising one or more actuation mechanisms coupled to the at least one mandrel section and actuable to move the at least one mandrel section from the retracted position to an extended position with respect to the mandrel body; forming a CMC ply assembly on the thermally expanding material; positioning one or more tooling portions outwardly from the CMC ply assembly, the one or more tooling portions defining a forming surface facing the CMC ply assembly; actuating the one or more actuation mechanisms to move the at least one mandrel section from the retracted position to the extended position, wherein movement of the at least one mandrel section from the retracted position to the extended position presses the thermally expanding material and the CMC ply assembly toward the forming surface; and thermally processing the thermally expanding material and the CMC ply assembly.

The method of any preceding clause, wherein disposing the thermally expanding material on at least the portion of the mandrel comprises disposing a room temperature vulcanizing (RTV) material on at least the portion of the mandrel.

The method of any preceding clause, wherein actuating the one or more actuation mechanisms to move the at least one mandrel section from the retracted position to the extended position comprises actuating the one or more actuation mechanisms to move at least one wedge-shaped mandrel section from the retracted position to the extended position.

The method of any preceding clause, wherein actuating the one or more actuation mechanisms comprises rotating or sliding at least one actuator body of the actuation mechanism.

The method of any preceding clause, wherein the mandrel body defines one or more first forming surfaces, and wherein the mandrel section defines one or more second forming surfaces, and wherein actuating the one or more actuation mechanisms to move the at least one mandrel section from the retracted position to the extended position comprises moving the at least one mandrel section to position the one or more second forming surfaces in a non-stepped and non-gapped arrangement with respect to the one or more first forming surfaces.

The method of any preceding clause, wherein the at least one mandrel section comprises a first mandrel section and a second mandrel section, and wherein actuating the one or more actuation mechanisms comprises moving the first mandrel section independently of the second mandrel section.

The method of any preceding clause, wherein the at least one mandrel section comprises a first mandrel section and a second mandrel section, and wherein actuating the one or more actuation mechanisms comprises moving the first mandrel section in a ganged manner.

The method of any preceding clause, wherein actuating the one or more actuation mechanisms comprises slidably moving at least one actuator body with respect to the at least one mandrel section.

A method for forming a ceramic matrix composite (CMC) component, comprising: positioning a mandrel supporting a CMC ply assembly into an inner space defined between first and second tooling portions, wherein the first and second tooling portions define one or more first forming surfaces at least partly defining a contour of the composite component, wherein the mandrel comprises a mandrel body defining an interior cavity and one or more second forming surfaces, and wherein the mandrel further comprises at least one mandrel section defining one or more third forming surfaces and movable from a retracted position within the interior cavity to an extended position, wherein, in the extended position, the one or more third forming surfaces are positioned to form a smooth transition to the one or more second forming surfaces; actuating one or more actuation mechanisms to move the at least one mandrel section from the retracted position to the extended position to press the CMC ply assembly toward the one or more first forming surfaces; and densifying the CMC ply assembly.

A method for forming a ceramic matrix composite (CMC) component, comprising: providing a mandrel comprising a rigid mandrel body defining one or more first forming surfaces and one or more rigid mandrel sections defining one or more second forming surfaces, wherein the one or more mandrel sections are movably positionable with respect to the mandrel body, and wherein the one or more mandrel sections are in a retracted position such that the one or more second forming surfaces are located offset in a radially inward direction with respect to the one or more first forming surfaces; laying up a CMC ply assembly on the mandrel such that a first portion of the CMC ply assembly is disposed over the one or more first forming surfaces and a second portion of the CMC ply assembly is disposed over the one or more second forming surfaces; enclosing the mandrel with the CMC ply assembly thereon within an inner space defined by one or more tooling portions; actuating one or more actuation mechanisms to move the one or more mandrel sections with respect to the mandrel body such that the second portion of the CMC ply assembly is moved into an intended position with respect to the first portion of the CMC ply assembly; and thermally processing the CMC ply assembly.

An apparatus for forming a composite component, the apparatus comprising: a mandrel defining one or more forming surfaces at least partly defining a profile of the composite component; a thermally expanding material disposed on at least a portion of the one or more forming surfaces; and an insert embedded in the thermally expanding material, the insert providing a first stiffness level in a first direction with respect to the thermally expanding material and a second stiffness level in a second direction with respect to the thermally expanding material, wherein the first stiffness level is greater than the second stiffness level.

The apparatus of any preceding clause, wherein at least a portion of the insert contacts the mandrel.

The apparatus of any preceding clause, wherein the insert comprise a metal insert.

The apparatus of any preceding clause, wherein the mandrel comprises at least one movable mandrel section.

The apparatus of any preceding clause, wherein at least a portion of the insert contacts the at least one mandrel section.

The apparatus of any preceding clause, wherein the insert comprises a plurality of spaced apart flange portions.

The apparatus of any preceding clause, wherein the insert comprises a curved portion and a flange portion extending from the curved portion toward the mandrel.

The apparatus of any preceding clause, wherein the flange portion contacts the mandrel.

The apparatus of any preceding clause, wherein the insert comprises: a first flange portion having a first end located proximate to the mandrel and a second end located distal to the first end; one or more second flange portions spaced apart from the first flange portion; and a curved portion connecting the first flange portion to the one or more second flange portions.

The apparatus of any preceding clause, wherein at least one second flange portion of the one or more second flange portions includes one or more tab portions extending toward the first flange portion.

An apparatus for forming a composite component, the apparatus comprising: a thermally expanding material formed as a sleeve and positionable over a mandrel, the mandrel at least partly defining a profile of the composite component; and an insert embedded in the thermally expanding material, the insert providing a first stiffness level in a first direction with respect to the thermally expanding material and a second stiffness level in a second direction with respect to the thermally expanding material, wherein the first stiffness level is greater than the second stiffness level.

The apparatus of any preceding clause, wherein the thermally expanding material comprises a room temperature vulcanizing (RTV) material.

The apparatus of any preceding clause, wherein the insert comprises a metal insert.

The apparatus of any preceding clause, wherein the insert comprises a plurality of spaced apart flange portions.

The apparatus of any preceding clause, wherein the insert comprises a curved portion and a flange portion extending from the curved portion.

The apparatus of any preceding clause, wherein the sleeve comprises an interior surface and an exterior surface, and wherein the insert comprises: a first flange portion having a first end located proximate to the interior surface and a second end located distal to the first end; one or more second flange portions spaced apart from the first flange portion; and a curved portion connecting the first flange portion to the one or more second flange portions.

The apparatus of any preceding clause, wherein the curved portion is located proximate the exterior surface.

The apparatus of any preceding clause, wherein at least one second flange portion of the one or more second flange portions includes one or more tab portions extending toward the first flange portion.

The apparatus of any preceding clause, wherein the one or more tab portions are disposed proximate the interior surface.

An apparatus for forming a composite component, the apparatus comprising: a mandrel comprising a mandrel body and at least one mandrel section movably coupled to the mandrel body; and a thermally expanding material disposed on at least a portion of the at least one mandrel section, wherein the thermally expanding material comprises at least one embedded insert positioned proximate the at least one mandrel section, the at least one embedded insert providing a stiffness of the thermally expanding material in a direction of movement of the at least one mandrel section.

The apparatus of any preceding clause, wherein the insert is positioned to contact the at least one mandrel section.

The apparatus of any preceding clause, wherein the thermally expanding material defines an interior surface facing the at least one mandrel section and an exterior surface disposed opposite the interior surface, and wherein the insert extends from the interior surface to the exterior surface.

The apparatus of any preceding clause, wherein the thermally expanding material defines an interior surface facing the at least one mandrel section and an exterior surface disposed opposite the interior surface, wherein the exterior surface is disposed in a radially outward direction with respect to the at least one mandrel section, and wherein the insert provides a first stiffness level in the radially outward direction with respect to the thermally expanding material and a second stiffness in a lateral direction with respect to the thermally expanding material, wherein the first stiffness is greater than the second stiffness.

The apparatus of any preceding clause, wherein the insert comprises a first flange portion and a second flange portion spaced apart from the first flange portion in the lateral direction.

The apparatus of any preceding clause, wherein the first and second flange portions are positioned to contact the at least one mandrel section.

The apparatus of any preceding clause, wherein the first flange portion includes one or more tab portions extending toward the second flange portion.

The apparatus of any preceding clause, wherein the first and second flange portions are disposed in a parallel arrangement.

An apparatus for forming a composite component, the apparatus comprising: a thermally expanding material defining a first surface positionable over a mandrel and a second surface opposite the first surface on which a ply assembly may be formed; and an insert embedded in the thermally expanding material, the insert providing a first stiffness level in a first direction with respect to the thermally expanding material and a second stiffness in a second direction with respect to the thermally expanding material, wherein the first stiffness is greater than the second stiffness.

A method for forming a composite component, the method comprising: positioning a thermally expanding material having an insert embedded in the thermally expanding material on a mandrel, the insert providing a first stiffness level in a first direction with respect to the thermally expanding material and a second stiffness in a second direction with respect to the thermally expanding material, wherein the first stiffness is greater than the second stiffness; laying up a ply assembly on the thermally expanding material; and thermally processing the thermally expanding material and the ply assembly.

The method of any preceding clause, further comprising positioning the thermally expanding material such that the insert contacts the mandrel.

The method of any preceding clause, wherein the mandrel comprises at least one movable mandrel section, and further comprising positioning the thermally expanding material such that the insert is disposed radially outward from the at least one mandrel section.

The method of any preceding clause, further comprising moving the at least one mandrel section radially outward toward the insert.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An apparatus for forming a composite component, the apparatus comprising:
a mandrel body defining one or more first forming surfaces on which the composite component can be formed, the mandrel body defining an interior cavity;
a mandrel section movably coupled to the mandrel body, the mandrel section defining one or more second forming surfaces on which the composite component can be formed, the mandrel section movable from a retracted position within the interior cavity to an extended position, wherein, in the extended position, the one or more second forming surfaces are positioned to form a smooth transition to the one or more first forming surfaces; and
an actuation mechanism actuable to move the mandrel section from the retracted position to the extended position.

2. The apparatus of claim 1, wherein the mandrel section is wedge-shaped.

3. The apparatus of claim 1, wherein the actuation mechanism comprises an actuator body slidably coupled to the mandrel section.

4. The apparatus of claim 1, wherein the actuation mechanism comprises an actuator body positioned to contact the mandrel section at two spaced apart locations.

5. The apparatus of claim 1, wherein the actuation mechanism comprises:
an actuator body; and
a rotatable member threadably coupled to the actuator body, wherein rotation of the rotatable member causes movement of the actuator body with respect to the mandrel section.

6. The apparatus of claim 1, wherein the actuation mechanism is disposed at least partly in the interior cavity.

7. The apparatus of claim 1, wherein the actuation mechanism comprises one or more ramp elements in slidable engagement with one or more ramp elements formed on the mandrel section.

8. An apparatus for forming a composite component, the apparatus comprising:
a mandrel body defining one or more first forming surfaces on which the composite component can be formed, the mandrel body defining an interior cavity;
a mandrel section movably coupled to the mandrel body, the mandrel section being wedged-shaped and defining one or more second forming surfaces on which the composite component can be formed, the mandrel section movable from a retracted position within the interior cavity to an extended position; and
an actuation mechanism actuable to move the mandrel section from the retracted position to the extended position.

9. The apparatus of claim 8, wherein the actuation mechanism comprises an actuator body slidably coupled to the mandrel section.

10. The apparatus of claim 8, wherein the actuation mechanism comprises an actuator body positioned to contact the mandrel section at two spaced apart locations.

11. The apparatus of claim 8, wherein the actuation mechanism comprises:
an actuator body; and
a rotatable member threadably coupled to the actuator body, wherein rotation of the rotatable member causes movement of the actuator body with respect to the mandrel section.

12. The apparatus of claim 8, wherein the actuation mechanism is disposed at least partly in the interior cavity.

13. The apparatus of claim 8, wherein the actuation mechanism comprises one or more ramp elements in slidable contact with one or more ramp elements formed on the mandrel section.

14. The apparatus of claim 13, wherein at least one ramp element of the actuation mechanism comprises:
an inclined surface; and
a landing area extending from the inclined surface.

15. The apparatus of claim 8, wherein the actuation mechanism comprises at least one first ramp element having a first inclined surface and a first landing area extending from the first inclined surface, and wherein the mandrel section comprises at least one second ramp element having a second inclined surface and a second landing area extending from the second inclined surface, and wherein, in the extended position, the first landing area is in engagement with the second landing area.

16. The apparatus of claim 8, wherein the actuation mechanism moves the mandrel section from the retracted position to the extended position based on at least one of a rotational or a sliding actuation.

17. A method of forming a ceramic matrix composite (CMC) component, the method comprising:
disposing a thermally expanding material on at least a portion of a mandrel, the mandrel comprising a mandrel body defining an interior cavity, wherein the mandrel comprises at least one mandrel section located in a retracted position within the interior cavity, the at least one mandrel section movably coupled to the mandrel body, the mandrel further comprising one or more actuation mechanisms coupled to the at least one mandrel section and actuable to move the at least one mandrel section from the retracted position to an extended position with respect to the mandrel body;
forming a CMC ply assembly on the thermally expanding material;
positioning one or more tooling portions outwardly from the CMC ply assembly, the one or more tooling portions defining a forming surface facing the CMC ply assembly;
actuating the one or more actuation mechanisms to move the at least one mandrel section from the retracted position to the extended position, wherein movement of the at least one mandrel section from the retracted position to the extended position presses the thermally expanding material and the CMC ply assembly toward the forming surface; and
thermally processing the thermally expanding material and the CMC ply assembly.

18. The method of claim 17, wherein disposing the thermally expanding material on at least the portion of the mandrel comprises disposing a room temperature vulcanizing (RTV) material on at least the portion of the mandrel.

19. The method of claim 17, wherein actuating the one or more actuation mechanisms to move the at least one mandrel section from the retracted position to the extended position comprises actuating the one or more actuation mechanisms to move at least one wedge-shaped mandrel section from the retracted position to the extended position.

20. The method of claim 17, wherein actuating the one or more actuation mechanisms comprises rotating or sliding at least one actuator body of the actuation mechanism.
